(19) United States
(12) Patent Application Publication
(10) Pub. No.: US 2002/0069520 A1
(43) Pub. Date: Jun. 13, 2002

(54) Wire depressor for a terminal applicator

(76) Inventors: Charles E. Erisman, Harrisburg, PA (US); Richard O. Wilson, Harrisburg, PA (US)

Correspondence Address: Tyco Technology Resources, Suite 450, 4550 New Linden Hill Road, Wilmington, DE, 19808-2952, US

(21) Appl. No.: 09/733,102

(22) Filed: Dec. 9, 2000

(51) Int. Cl. B23P 19/00

(52) U.S. Cl. 29/753; 29/745

(57) ABSTRACT

A machine (10) for attaching electrical terminals (12) to a wire conductor (14) includes a wire depressor (50) for guiding the individual strand of the conductor into proper seating engagement with the terminal and holding the conductor in that position during the crimping cycle. The wire depressor includes a fixed member (52) that is removable secured to the ram (34) of the machine (10) and a movable member (55) in sliding engagement with the fixed member. One or more resilient members (54) are arranged between the fixed member and the movable member to urge the movable member into pressing engagement with the conductor while permitting the ram to continue its movement during the crimping cycle.

The present invention relates to machines for crimping electrical terminals onto conductors, and more particularly to a spring-loaded depressor operationally coupled to the machine for holding the conductor in place during the crimping operation thereof.

### BACKGROUND OF THE INVENTION

Terminal applicator machines are widely used in the industry to attach electrical terminals to conductors. These terminal applicators may be used manually where an operator inserts an already prepared wire end into the crimping area between a crimping tool and an anvil containing a terminal and holds the wire in place while activating the applicator to complete the termination or, the terminal applicator may be attached to a host machine, such as a lead maker, where the prepared wire end is automatically presented to the applicator tooling for termination. Occasionally, for a variety of reasons, a wire end cannot be easily positioned in the open terminal so that when the applicator executes its crimping cycle, the resulting termination may be defective. This is particularly true of stranded conductors where one or two strands can be inadvertently positioned outside of the sides of the crimping barrel of the open terminal. After crimping, such a termination may be loose or contain voids resulting in a defective and unreliable termination. Such a problem can be caused by a particularly flexible wire that is hard to correctly position, a wire having an oversized insulation diameter for the terminal, a conductor having a large number of strands, a conductor diameter that leaves little clearance between the conductor and the sides of the open terminal barrel as the conductor is being positioned for crimping, and where the sides of the open terminal barrel are very short and do not provide enough lead in for the conductor. In such cases a wire depressor is used to guide the conductor strands into position within the open terminal barrel just prior to crimping the terminal. There any a number of wire depressors in use that are effective. These wire depressors are arranged between the crimping tool that crimps the wire barrel of the terminal and the tool that crimps the insulation barrel. The wire depressor is spring loaded toward the anvil and must be located closely adjacent the wire crimping tool so that it can engage and guide the bare stranded portion of the wire without interfering with the operation of the wire crimping tool. There is usually a spacer between the wire crimping tool and the insulation crimping tool, which is replaced by the wire depressor when need. This is something that is usually done in the field by the end user of the terminal applicator. Since the available spacing for the wire depressor is quite limited, such wire depressors utilize a modified ram or modified crimping tool to provide an attachment point and space for a spring member to urge the wire depressor toward the anvil. This, of course, necessitates stocking the modified rams or modified crimping tools so that when the need for a wire depressor arises, it can be accommodated. If the required modified ram or crimping tool is not immediately available, then production must stop until the required part is obtained. Because the spring member is arranged within a cavity in the modified ram or crimping tool, the spring member is difficult to access for repair or replacement when attempting to adjust the level of pressure exerted by the wire depressor. Another type of wire depressor avoids the necessity of requiring a modified ram or crimping tool by maintaining all of the parts of the wire depressor within a limited thickness. Such a wire depressor is disclosed in U.S. Pat. No. 5,274,909 which issued Jan. 4, 1994 to Listing. The Listing wire depressor is of unitary construction and manufactured by means of wire EDM. It includes an outer frame that has a wire depressor form on one end and an inner frame that is within a cavity of the outer frame and in sliding engagement therewith for relative sliding motion along its longitudinal axis. A pair of spring members are disposed within the cavity between the two frames. The two frames and the spring members are integrally formed from a single flat piece of material. The inner frame is attached to the ram of the applicator and the outer frame is then biased in the direction of the terminal to be crimped by the two spring members. A serious drawback with this wire depressor is that the spring member is integral to the unit and cannot be removed for replacement if a different depression force is desired or if the spring member becomes defective.

What is needed is a wire depressor that is completely self contained and wherein the spring member can be easily accessed and replaced if desired, prior to assembly to the applicator. The wire depressor will replace the spacer between the wire crimping tool and the insulation crimping tool, and will properly function with the existing ram and wire crimping tool. Such a wire depressor effectively completely avoids the problem of stocking modified rams or crimping tools and of the difficulty of accessing and replacing the spring member.

### SUMMARY OF THE INVENTION

A machine for attaching an electrical terminal to a conductor, includes a frame, an anvil, and a ram slidingly coupled to the frame. The ram is arranged to undergo reciprocating motion along a ram axis in a first direction toward the anvil into crimping engagement with the electrical terminal and in a second direction out of crimping engagement. The ram includes tooling for interacting with the anvil for attaching the electrical terminal to the conductor. A wire depressor is provided which includes a fixed member attached to and carried by the ram, the fixed member having a first abutting surface. A movable member is included, separate from but in sliding engagement with the fixed member for sliding movement along the ram axis, and includes a second abutting surface opposed to the first abutting surface, and a wire engaging surface. A resilient means is arranged between and in abutting engagement with the first and second abutting surfaces so that the movable member is urged to move in the first direction.

An embodiment of the invention will now be described by way of example with reference to the following drawings.

### DESCRIPTION OF THE DRAWINGS

FIG. 1 is an isometric view of a terminal applicator incorporating the teachings of the present invention;

FIG. 2 is an isometric view of the ram assembly shown in FIG. 1;

FIG. 3 is an exploded parts view of the ram assembly of FIG. 2, showing the wire depressor;

FIGS. 4 and 5 are front views of the ram assembly, with some parts removed, showing the wire depressor in different operating positions;

FIGS. 6, 7, and 8 are front, side and top views, respectively of the fixed member of the wire depressor; FIGS. 9 and 10 are front and side views, respectively of the movable member of the wire depressor;

FIG. 11 is an enlarged top view of the movable member;

FIG. 12 is an enlarged partial side view of the movable member;

FIG. 13 is a cross-sectional view taken along the lines 13-13 in FIG. 4; and

FIG. 14 is an enlarged side view of a portion of the wire depressor taken along the lines 14-14 in FIG. 4.

### DESCRIPTION OF AN EMBODIMENT OF THE INVENTION

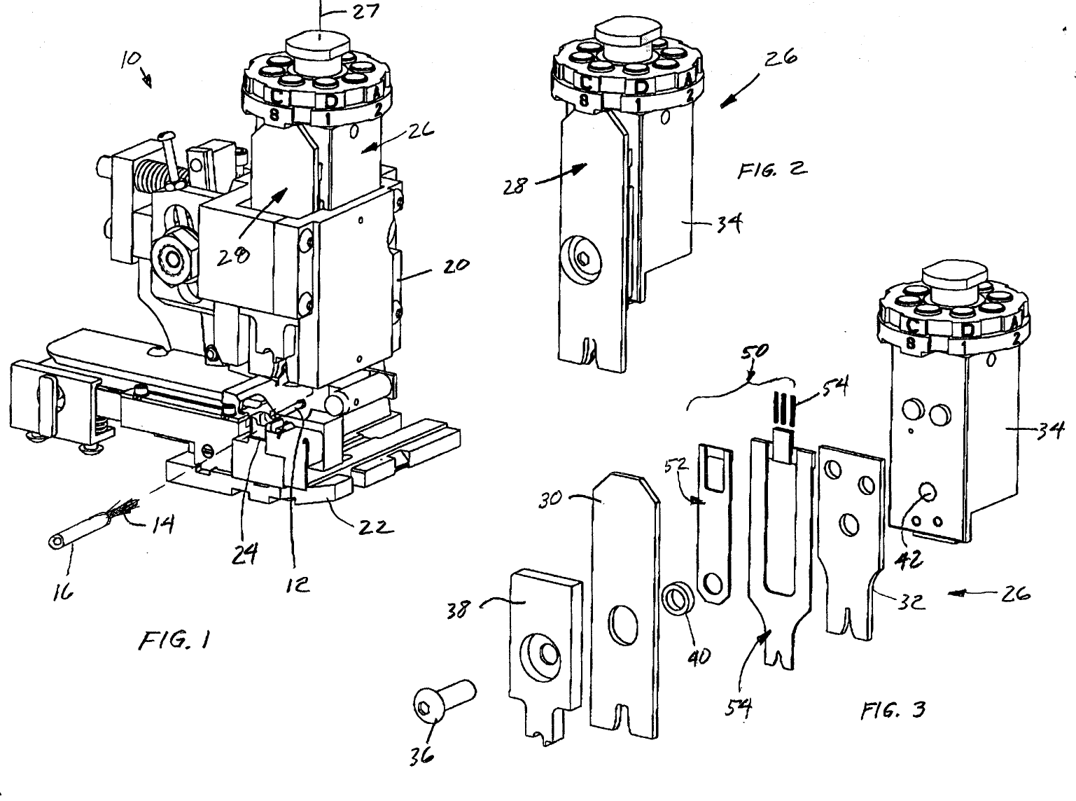

There is shown in FIG. 1 a terminal applicator 10 for crimping an electrical terminal 12 onto a conductor 14 of a wire 16. The applicator includes a frame 20, base 22 that supports an anvil 24, and a ram assembly 26 that is arranged to undergo reciprocating movement toward the anvil and away therefrom along a ram axis 27. The ram assembly 26, shown in FIG. 2, carries tooling 28 that includes an insulation crimping tool 30 and a conductor barrel crimping tool 32, as best seen in FIG. 3, which are attached to a ram 34 by means of a screw 36. The screw 36 extends through a hole in a backing plate 38, an elongated hole in the insulation crimping tool 30 and its spacer 40, a hole in the conductor barrel crimping tool 32, and into a threaded hole 42 in the ram 34. This is a customary arrangement well known in the industry. In most cases there is a standard thickness spacer, not shown, that is disposed between the insulation crimping tool 30 and the conductor barrel crimping tool 32 to properly space the two crimping tools with respect to the terminal 12. When a wire depressor is needed, the spacer is removed and the wire depressor in inserted in its place. As set forth above, the wire depressor usually requires some special attachment to either one of the crimping tools or the ram itself. However, in the present case such special attachment is not needed. Therefore, FIG. 3 shows a wire depressor 50, incorporating the teachings of the present invention, disposed between the two crimping tools 30 and 32.

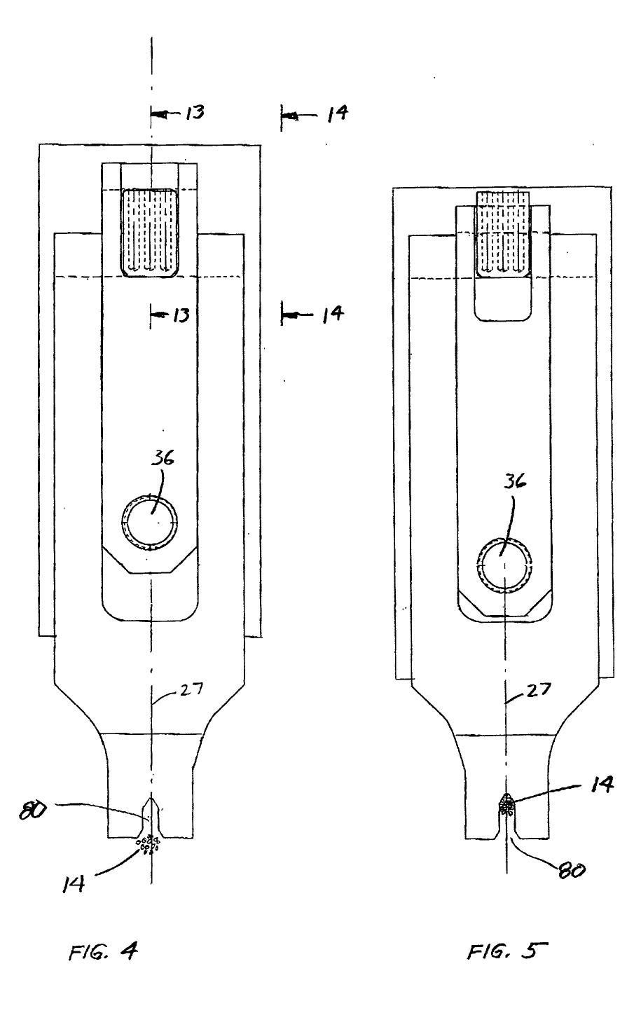

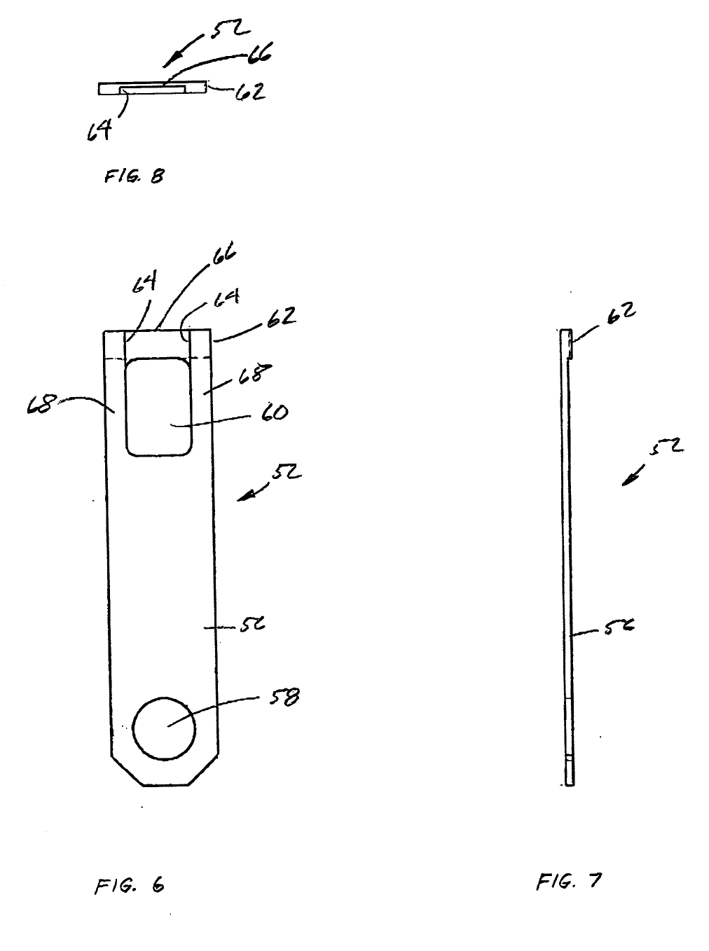

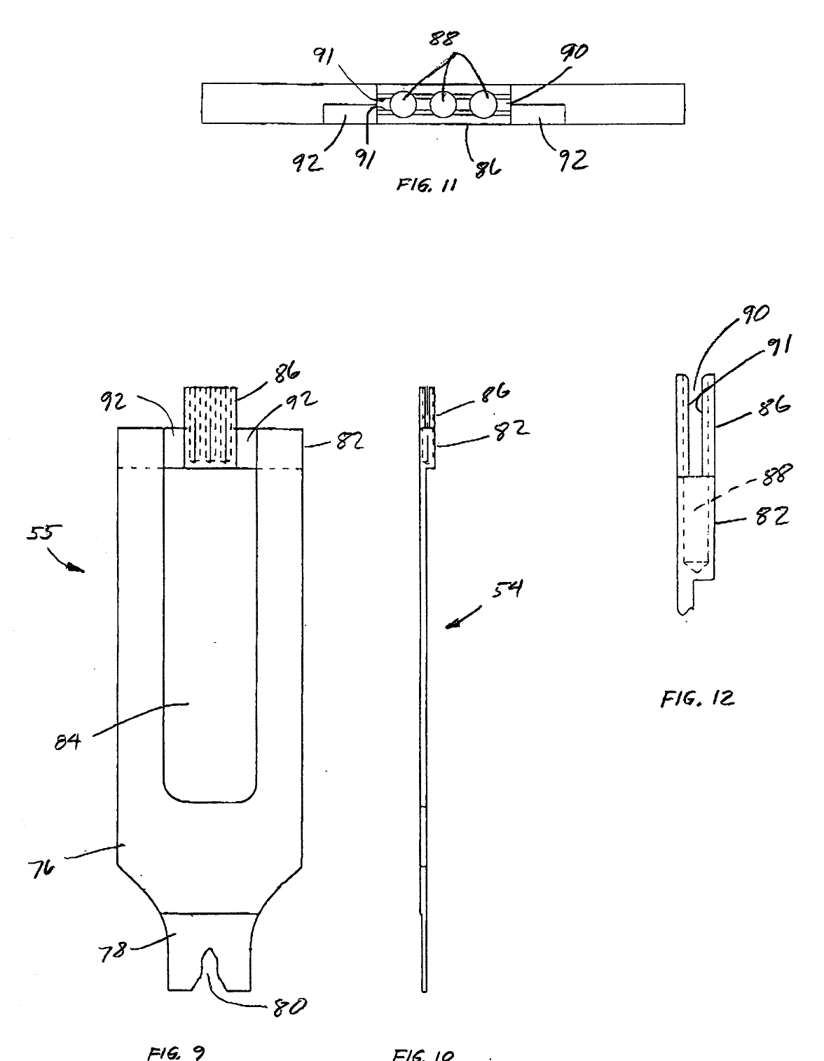

As shown in FIG. 3 the wire depressor 50 includes a fixed member 52, a movable member 55, and three compression springs 54. The fixed member, as best seen in FIGS. 6, 7, and 8, has a substantially flat and thin elongated shank 56 having a hole 58 at one end that closely receives the screw 36. The other end has an opening 60 formed therethrough that terminates at a thicker portion 62. A recess 64 is formed in the surface of the thicker portion thereby forming a relatively thin blade 66 that is offset from the general plane of the shank 56. The opening 60 defines side rails 68 that extend from the shank 56 to the thicker portion 62. The movable member 55, as best seen in FIG. 9, 10, 11, and 12, includes a main body 76, a depressor end 78 having an conductor seat 80 for gathering and positioning the strands of the conductor, and a thicker end 82 opposite the depressor end. The main body 76 includes an elongated opening 84 therethrough that begins near the depressor end and extends to the thicker end 82, as shown in FIG. 9. A boss 86 extends outwardly from the thicker end 82 and includes three blind holes 88 formed into most of the depth of the boss but not through into the elongated opening 84. A transverse slot 90 is formed through the boss 86 so that the slot intersects the three holes 88, thereby defining two side walls 91, as best seen in FIGS. 1 and 12. A pair of recesses 92 are formed into the main body 76 on opposite sides of the boss 86 and are sized to closely receive the side rails 68 of the fixed member 52. The opening 84 is also sized to closely receive the shank 56 of the fixed member as shown in FIGS. 4 and 5.

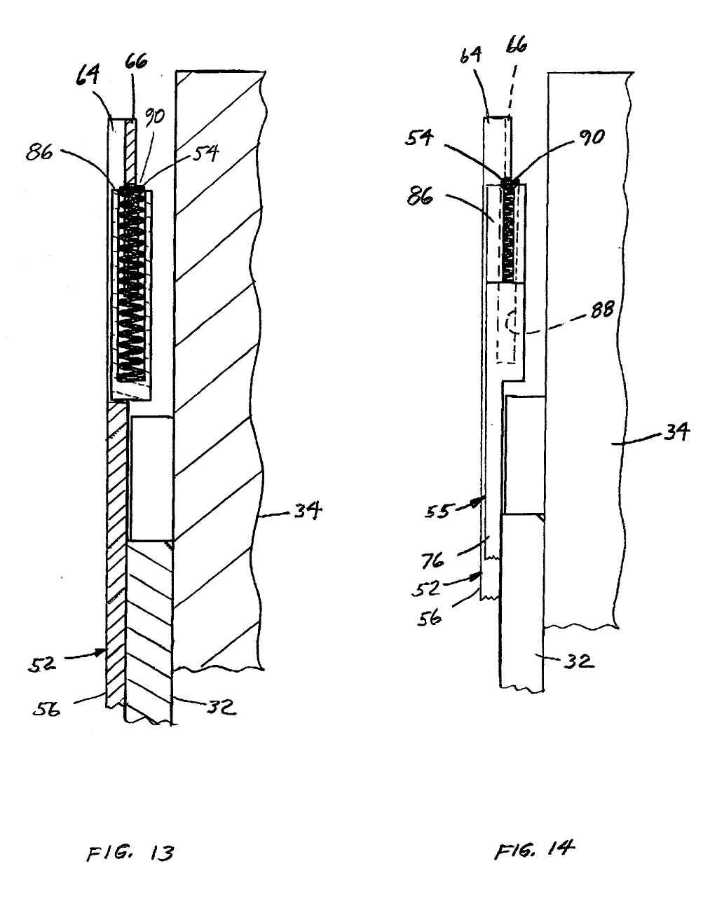

The thin blade 66 is offset from the general plane of the shank 56 so that when the fixed member 52 is in position within the opening 84, as shown in FIGS. 4 and 5, the thin blade is in alignment with the slot 90, as best seen in FIG. 13. The slot 90 is wide enough to receive the thin blade with clearance. As shown in FIGS. 4, 13, and 14, the shank 56 is in sliding engagement with the movable member in the elongated opening 84 and the side rails 68 are nestled within the two recesses 92 so that the boss 86 is within the opening 60. The thickness of the fixed member 52 is slightly more than the thickness of the movable member 55 so that when the screw 36 is tightened, the fixed member is secured tightly against the conductor barrel crimping tool 32 and to the ram 34. However, the movable member is free to slide vertically, with respect to FIG. 4, along the ram axis 27.

In operation, when it is determined that a wire depressor is needed, the ram assembly is removed from the applicator 10 and the screw 36 removed. The spacer, not shown, is then replaced by the wire depressor 50 and the screw 36 is then reinserted and tightened so that the fixed member 52 is secured tightly to the assembly. When terminating terminals having a relatively large distance between the conductor barrel and the insulation barrel a thinner spacer may be required to locate the insulation crimping tool with respect to the insulation barrel. The ram assembly 26 is then reassembled to the applicator. The crimping cycle begins from the starting position, shown in FIG. 13. The ram assembly 26 is caused to begin moving downwardly in a first direction toward the anvil 24 carrying the fixed member 52 with it. As this occurs the blade 66 of the fixed member is urged against the top ends of the compression springs 54 thereby urging the movable member to also move in the first direction so that the conductor seat 80 begins to confine and guide the individual strands of the conductor 14 into a confined grouping. As the ram movement continues, the conductor seat 80 fully engages the conductor 14, seating it in the conductor barrel of the terminal 12. At this point the blade 66 enters the transverse slot 90 of the boss 86 and begins to compress the springs 54 which, in turn, cause the wire depressor to exert a force on the conductor holding it in proper position, as shown in FIG. 5, as the ram assembly approaches the end of its downward stroke and crimps the conductor barrel onto the conductor 12 and the insulation barrel onto the insulated portion of the wire 16. The ram assembly then retracts in the usual manner and returns to the starting position shown in FIG. 4. At the very bottom of the stroke, a known force is exerted on the conductor 14 by virtue of the three known compression springs. Sometimes this known force must be increased or decreased to fit the requirements of a particular terminal type and wire type combination. This known force can easily be controlled by selecting stronger or weaker compression springs 54. Further force control can be obtained by optionally utilizing only a single compression spring 54 or two compression springs, as desired.

While standard compression springs 54 are described herein, it will be understood that other resilient mechanisms may be utilized within the scope of the present claims. Such resilient mechanisms may include, for example, elastic material, leaf spring members, or torsion spring members, as well as other resilient members.

An important advantage of the present invention is that this wire depressor can easily be assembled to the terminal applicator in the field by the operator. Another important advantage is that the wire depressor requires no special applicator parts such as a specially made ram or special crimping tooling, therefore, production is not adversely affected and there is no need to stock extra parts. Additionally, the force that is applied by the wire depressor is easily adjusted by the operator by simply inserting a desired size and number of compression springs when the wire depressor is assembled to the applicator. Further, the compression springs of the wire depressor can be easily replaced by the operator should they fail.

We claim:

1. In a machine for attaching an electrical terminal to a conductor, including a frame, an anvil, and a ram slidingly coupled to said frame and arranged to undergo reciprocating motion along a ram axis in a first direction toward said anvil into crimping engagement with said electrical terminal and in a second direction out of said crimping engagement, said ram including tooling for interacting with said anvil for effecting said attaching of said electrical terminal, a wire depressor comprising:
(1) a fixed member, attached to and carried by said ram, having a first abutting surface;
(2) a movable member, separate from but in sliding engagement with said fixed member for sliding movement along said ram axis, having a second abutting surface opposed to said first abutting surface, and a wire engaging surface; and
(3) a resilient means arranged between and in abutting engagement with said first and second abutting surfaces so that said movable member is urged to move in said first direction.

2. The wire depressor according to claim 1 wherein said fixed member is attached to said ram at a point between said resilient means and said wire engaging surface.

3. The wire depressor according to claim 2 wherein said second abutting surface is a bottom surface of an opening defined by two side walls and said bottom surface and said resilient means is disposed between said two side walls.

4. The wire depressor according to claim 3 wherein said first abutting surface is received between said two side walls.

5. The wire depressor according to claim 1 wherein said resilient means is at least one compression spring.

6. The wire depressor according to claim 5 wherein said movable member includes at least one hole having its axis substantially parallel to said ram axis wherein said second abutting surface is a bottom of said at least one hole, each of said at least one hole arranged for receiving an end of said at least one compression spring the other end of which is in abutting engagement with said first abutting surface.

7. The wire depressor according to claim 6 wherein said at least one compression spring includes a plurality of compression springs and said first abutting surface engages said another end of each of said plurality of compression springs.

8. The wire depressor according to claim 7 wherein said movable member has an opening that intersects said at least one hole and receives said first abutting surface in said opening when said movable member is moved in said first direction.

9. The wire depressor according to claim 8 wherein said plurality of compression springs is exactly two compression springs.

10. The wire depressor according to claim 8 wherein said plurality of compression springs is exactly three compression springs.

11. In a machine for attaching an electrical terminal to a conductor, including a frame, an anvil, and a ram slidingly coupled to said frame and arranged to undergo reciprocating motion along a ram axis in a first direction toward said anvil into crimping engagement with said electrical terminal and in a second direction out of said crimping engagement, said ram including tooling for interacting with said anvil for effecting said attaching of said electrical terminal, a wire depressor comprising:
(1) a fixed member removably attached to and carried by said ram;
(2) a movable member slidingly coupled to said fixed member for sliding movement along said ram axis; and
(3) a resilient means arranged between said fixed member and said movable member so that said movable member is urged to move in said first direction,
wherein neither said ram nor said tooling require any special modification to accommodate said wire depressor.

12. The machine according to claim 11 wherein said fixed member is attached to said ram by means of a fastener that attaches said tooling to said ram.

13. The machine according to claim 12 wherein said tooling includes a conductor barrel crimping tool and an insulation crimping tool and wherein said wire depressor is disposed between said conductor barrel crimping tool and said insulation crimping tool.

14. A wire depressor comprising:
(1) a fixed member, removably attachable to a ram of a machine for crimping an electrical terminal to a conductor, having a first abutting surface, said ram carrying crimping tooling and arranged to move in a first direction along a ram axis for effecting said crimping;
(2) a movable member, separate from but in sliding engagement with said fixed member for sliding movement along said ram axis, having a second abutting surface opposed to said first abutting surface, and a wire engaging surface; and
(3) a resilient means arranged between and in abutting engagement with said first and second abutting surfaces so that said movable member is urged to move in said first direction,
wherein said wire depressor requires no special modifications to either said ram or said crimping tooling.

15. The wire depressor according to claim 14 wherein said fixed member is attached to said ram at a point between said resilient means and said wire engaging surface.

16. The wire depressor according to claim 15 wherein said resilient means is at least one compression spring.

17. The wire depressor according to claim 16 wherein said movable member includes at least one hole, wherein said second abutting surface is a bottom of said at least one hole, each of said at least one hole arranged for receiving an end of said at least one compression spring the other end of which is in abutting engagement with said first abutting surface.

18. The wire depressor according to claim 17 wherein said at least one compression spring includes a plurality of compression springs and said first abutting surface engages said another end of each of said plurality of compression springs.

19. The wire depressor according to claim 18 wherein said movable member has an opening that intersects said at least one hole and receives said first abutting surface in said opening when said movable member is moved in said first direction.

20. The wire depressor according to claim 19 wherein said plurality of compression springs is exactly two compression springs.

21. The wire depressor according to claim 20 wherein said plurality of compression springs is exactly three compression springs.
